(19) United States
(12) Patent Application Publication
(10) Pub. No.: US 2020/0409240 A1
(43) Pub. Date: Dec. 31, 2020

(54) FILTER ASSEMBLY AND OPTICAL CAMERA DEVICE

(71) Applicant: AAC Optics Solutions Pte. Ltd., Singapore city (SG)

(72) Inventor: Jarno Matikainen, Tampere (FI)

(21) Appl. No.: 16/729,509

(22) Filed: Dec. 30, 2019

(30) Foreign Application Priority Data
Jun. 27, 2019 (CN) 201920989710.X

(51) Int. Cl. G03B 17/12; G03B 11/00

(52) U.S. Cl. CPC G03B 17/12; G03B 11/00

(57) ABSTRACT

The present invention relates to a filter assembly includes a substrate including a surrounding wall forming an inner cavity and an extension wall extending from the surrounding wall into the inner cavity of the substrate, a filter mounted on the substrate, and a spacer fixed to a bottom surface of the extension wall. The extension wall forms a receiving cavity for receiving the filter, the filter is received in the receiving cavity, and a bottom portion of the filter is fixed to the spacer. A glue-receiving groove is formed between a side surface of the filter and a side surface of the extension wall. Glue is provided in the glue-receiving groove to bond the filter with the extension wall. The requirement on a height of the substrate when encapsulating the filter is reduced, thereby solving the problem that the encapsulation height of the existing filter assembly is over large.

### TECHNICAL FIELD

The present invention relates to the field of optical camera technology, and in particular, to a filter assembly and an optical camera device.

### BACKGROUND

A substrate (for example, being made of ceramic) in a filter assembly has properties such as high thermal conductivity and high electrical insulation strength, thereby becoming an ideal encapsulation material. As products such as mobile phones, digital cameras and PCs continue to evolve, the demand for filter assemblies is growing. In addition, with the requirement on the miniaturization of surface-mounting components and the miniaturization of products, the filter assembly is increasingly required to be thin and small.

Current digital products, especially in cameras, mostly adopt ceramic substrates, and components using ceramic encapsulation manufacturing technology generally have a stacked structure. Camera components such as a sensor (for example, an image sensor) and a filter (for example, an infrared filter) are stacked on an upper surface and a lower surface of the substrate. In the related art, a fixing method for the filter usually requires providing a boss (or a flange) on the substrate and applying glue between the boss and the filter, in order to fix the filter on the ceramic substrate. However, such a molding mode results in that a height of the filter assembly is over large (i.e., the size is over large), and it is difficult to meet the ultra-thin requirements on the current products if the size is over large.

Thus, there is an urgent need for a filter assembly and an optical camera device to solve the above problems.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a structural schematic diagram of a filter assembly provided by the present invention when being viewed in one perspective;

FIG. 2 is a structural schematic diagram of a filter assembly provided by the present invention when being viewed in another perspective;

FIG. 3 is a cross-sectional schematic diagram of a filter assembly provided by the present invention;

FIG. 4 is an enlarged schematic diagram in FIG. 3;

FIG. 5 is a cross-sectional schematic diagram of a substrate in FIG. 3.

### REFERENCE NUMERICAL

1—substrate;
   11—surrounding wall;
   12—extension wall;
   13—receiving cavity;
   14—glue-receiving groove;
   15—first inner cavity;
   16—second inner cavity;
2—filter;
3—spacer;
4—glue.

### DESCRIPTION OF EMBODIMENTS

The present invention will be further illustrated with reference to the accompanying drawings and the embodiments.

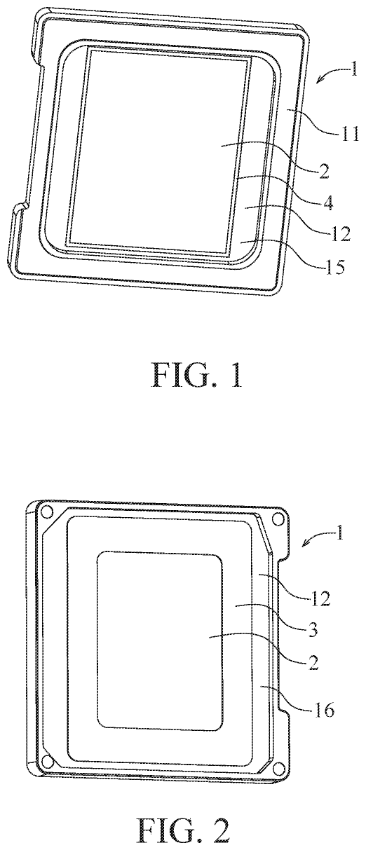

As shown in FIG. 1 and FIG. 2, both FIG. 1 and FIG. 2 are structural schematic diagrams of the filter assembly provided by the present invention. The filter assembly includes a substrate 1, a filter 2, a spacer 3, and glue 4. The filter 2 may be an infrared filter for filtering the infrared light.

The filter 2 is mounted in the substrate 1. Specifically, the substrate 1 includes a surrounding wall 11 forming an inner cavity of the substrate and an extension wall 12 extending from the surrounding wall 11 into the inner cavity of the substrate. The extension wall 12 forms a receiving cavity 13 for receiving the filter 2.

The filter 2 is received in the receiving cavity 13 by the spacer 3 and the glue 4 (see FIG. 5). Specifically, the spacer 3 is fixed to a bottom surface of the extension wall 12, and a bottom portion of the filter 2 is fixed to the spacer 3. A glue-receiving groove 14 is formed between a side surface of the filter 2 and a side surface of the extension wall 12 (see FIG. 4). The glue 4 is provided in the glue-receiving groove 14 to bond the filter 2 with the extension wall 12. The filter assembly provided by the present invention fixes the side surface of the filter 2 to the side surface of the extension wall 12 by providing the glue 4, and fixes the bottom portion of the filter 2 to the bottom surface of the extension wall 12 by providing the spacer 3, so that the requirement on a height of the substrate when encapsulating the filter is reduced, thereby solving the problem that the encapsulation height of the existing filter assembly is over large.

The glue-receiving groove 14 is disposed along a periphery of the filter 2, and the spacer 3 is also disposed along a periphery of the filter 2, so that the glue 4 and the spacer 3 achieve a good fixing effect on the filter 2.

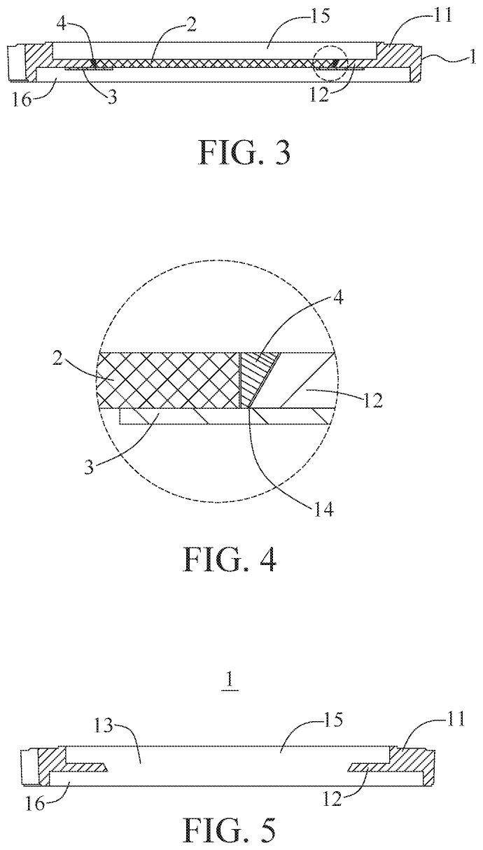

Referring to FIG. 3, the filter 2 and the extension wall 12 divide the inner cavity of the substrate into a first inner cavity 15 and a second inner cavity 16, and the spacer 3 is disposed in the second inner cavity 16, so that the first inner cavity 15 and the second inner cavity 16 can be used in mounting of electronic components or camera components, respectively. For example, an image sensor (not shown in the drawing) can be mounted in the second inner cavity 16. In a specific implementation, a bottom plate (not shown in the drawing) is fixed on a lower surface of the substrate 1 by glue, and the bottom plate and the substrate 1 form the second inner cavity 16. The image sensor is fixed on the bottom plate. In order to reduce the tilting effect of the sensor, a concave region for receiving the image sensor may be provided on the bottom plate.

In order to achieve that the second inner cavity 16 has a larger receiving space, in other words, in order to achieve that there is enough receiving space for the image sensor, an opening size of the first inner cavity 15 is preferably smaller than that of the second inner cavity 16.

Referring to FIG. 4, it is an enlarged schematic diagram in FIG. 3. Preferably, the glue-receiving groove 14 is a wedge-shaped groove. More specifically, the side surface of the extension wall 12 extends from a top surface of the extension wall 12 to the bottom surface of the extension wall 12 in a direction gradually approaching the filter 2. In such a manner, the bonding area of the glue 4 and the side surface of the extension wall 12 can be increased, thereby increasing the bonding strength and thus fixing the filter 3 more stably.

Referring to FIG. 1, FIG. 2 and FIG. 5, the substrate 1 provided by the present invention can be integrally molded, which can ensure the processing and molding efficiency of the substrate 1 and reduce the processing cost of the substrate 1. Preferably, the substrate 1 may be made of a ceramic material such that the substrate 1 has the advantages of high thermal conductivity and high electrical insulation strength.

The present invention also provides an optical camera device, and the optical camera device includes the filter assembly described above. By adopting the above filter assembly, the requirement on the height of the substrate by the optical camera device is reduced, thereby solving the problem that the encapsulation height of the existing filter assembly is over large.

The above is only a preferred embodiment of the present invention and is not used to limit the present invention. Any modifications, equivalent substitutions, improvements, etc., which are made within the spirit and principles of the present invention, should be included in scope of the present invention.

What is claimed is:

1. A filter assembly, comprising:
a substrate comprising a surrounding wall forming an inner cavity of the substrate and an extension wall extending from the surrounding wall into the inner cavity of the substrate;
a filter mounted on the substrate; and
a spacer fixed to a bottom surface of the extension wall;
wherein the extension wall forms a receiving cavity for receiving the filter, the filter is received in the receiving cavity, and a bottom portion of the filter is fixed to the spacer, a glue-receiving groove is formed between a side surface of the filter and a side surface of the extension wall, and glue is provided in the glue-receiving groove to bond the filter with the extension wall.

2. The filter assembly as described in claim 1, wherein the glue-receiving groove is a wedge-shaped groove.

3. The filter assembly as described in claim 2, wherein the side surface of the extension wall extends from a top surface of the extension wall to the bottom surface of the extension wall in a direction gradually approaching the filter.

4. The filter assembly as described in claim 1, wherein the glue-receiving groove is provided along a periphery of the filter.

5. The filter assembly as described in claim 1, wherein the filter and the extension wall divide the inner cavity of the substrate into a first inner cavity and a second inner cavity, and the spacer is provided in the second inner cavity.

6. The filter assembly as described in claim 5, wherein an opening size of the first inner cavity is smaller than that of the second inner cavity.

7. The filter assembly as described in claim 1, wherein the substrate is integrally molded.

8. An optical camera device comprising the filter assembly as described in claim 1.
